(19) United States
(12) Patent Application Publication
(10) Pub. No.: US 2017/0191566 A1
(43) Pub. Date: Jul. 6, 2017

(54) AEROSOL-BASED BEARING ISOLATOR FOR ATTACHMENT HEAD OF MACHINE TOOL

(71) Applicant: VISION WIDE TECH CO., LTD., TAICHUNG CITY (TW)

(72) Inventors: Sheng-Hsun HUNG, TAICHUNG CITY (TW); Sung-Chiang CHEN, TAICHUNG CITY (TW); Yasushi TANOUE, TAICHUNG CITY (TW)

(21) Appl. No.: 14/984,702

(22) Filed: Dec. 30, 2015

(51) Int. Cl. F16J 15/447; F16J 15/40

(52) U.S. Cl. CPC F16J 15/447; F16J 15/406

(57) ABSTRACT

An aerosol-based bearing isolator for an attachment head includes a sealing element having an axial hole centrally and having a compressed air path and a plurality of compressed air export channels, with the compressed air path disposed on an outer circumferential surface of the sealing element, and the compressed air export channels each having an end exposed from the compressed air path and thus being in communication with the compressed air path and an outside; and a compressed air guiding element having a compressed air import hole with an end exposed from an inner lateral surface of the compressed air guiding element to form an opening thereon, wherein the inner lateral surface of the compressed air guiding element abuts against the outer circumferential surface of the sealing element, thereby allowing the compressed air import hole to be in communication with the compressed air path.

### BACKGROUND OF THE INVENTION

Technical Field

The present invention relates to processing machines and more particularly to an aerosol-based bearing isolator for an attachment head of a machine tool.

Description of Related Art

Machine tools, such as lathes, milling machines, and drilling machines, are in wide use by contemporary factories to process work piece. Various machine tools operate in their respective processing modes. For example, lathes are dedicated to processing round work piece, milling machines to processing surfaces of work piece, and drilling machines to drilling holes in work piece.

A conventional attachment head always comprises a spindle and the spindle is mounted on the attachment head to clamp a processing tool for processing a workpiece. To minimize the effect of high heat generations by the processing point between the processing tool and work piece, the conventional machine tool always provides cutting fluid. The cutting fluid is sprayed onto a processing point between the processing tool and the workpiece to cool them. Because of high compressed of the cutting fluid, the cutting fluid is bounced back from the work piece; as a result, the attachment head is spattered with the cutting fluid inevitably. To prevent the cutting fluid from accumulating in the attachment head, a bearing isolator of the attachment head is equipped with a drainage mechanism for draining the cutting fluid from the attachment head. However, under specific processing conditions, the attachment head would be needed to tilt. For example, if an attachment head has rotating function on its spindle axis, the attachment head spindle can be rotated in multi-angle to process and thus the spindle is needed to change its angle more than 90 degrees in some cases of processing condition, which the spindle axis is over horizontal axis. Furthermore, when the spindle is not rotating, the cutting fluid is accumulated at below part of the bearing oil seal by gravity, after that the cutting fluid overflows the bearing isolators and intrude into the bearing of the spindle, thereby it damages the spindle of the attachment head.

Accordingly, it is imperative to overcome the aforesaid drawback of the prior art.

### SUMMARY

It is an objective of the present invention to provide an aerosol-based bearing isolator for an attachment head of a machine tool to prevent a cutting fluid from accumulating in an oil seal under any processing conditions.

In view of this, the present invention provides an aerosol-based bearing isolator for an attachment head of a machine tool. The aerosol-based bearing isolator comprises: a sealing element with having an axial hole centrally and having a compressed air path and a plurality of compressed air export channels, with the compressed air path disposed on an outer circumferential surface of the sealing element, and the compressed air export channels each having an end exposed from the compressed air path and thus being in communication with the compressed air path and an outside; and a compressed air guiding element having a compressed air import hole with an end exposed from an inner lateral surface of the compressed air guiding element to form an opening thereon, wherein the inner lateral surface of the compressed air guiding element abuts against the outer circumferential surface of the sealing element, thereby allowing the compressed air import hole to be in communication with the compressed air path.

In an embodiment, the compressed air path has its head and tail connected to each other and has a substantially V-shaped cross section.

In an embodiment, the compressed air export channels disposed on the sealing element are spaced apart equidistantly.

In an embodiment, the compressed air import hole of the compressed air guiding element is connected to an air compressor.

In an embodiment, the sealing element has an inner member and an outer member, wherein the compressed air path and the compressed air export channels are disposed on the outer member, wherein a gap is disposed between the inner member and the outer member, and the gap forms an annular opening on a lateral surface of the sealing element, wherein the compressed air export channels are in communication with the gap.

In an embodiment, a groove is disposed on the inner lateral surface of the compressed air guiding element and is in communication with the compressed air import hole and the compressed air path of the sealing element.

Therefore, given a compressed air compressed, a cutting fluid never accumulates in the sealing element under any processing conditions to disadvantageously compromise the operation of the sealing element.

### BRIEF DESCRIPTION OF THE DRAWINGS

FIG. 1 is a perspective view of an aerosol-based bearing isolator mounted on an attachment head spindle capable of multi-angle processing according to a preferred embodiment of the present invention;

FIG. 2 is an exploded view of an aerosol-based bearing isolator according to the preferred embodiment of the present invention;

FIG. 3 is a partial cross-sectional view of a sealing element according to the preferred embodiment of the present invention;

FIG. 4 is a partial cross-sectional view of a compressed air guiding element according to the preferred embodiment of the present invention; and

FIG. 5 is a partial cross-sectional view of the aerosol-based bearing isolator mounted on the attachment head spindle capable of multi-angle processing according to a preferred embodiment of the present invention.

### DETAILED DESCRIPTION OF THE EMBODIMENT OF THE INVENTION

To render the objectives, features and advantages of the present invention more comprehensible, the present invention is illustrated with diagrams and described hereunder.

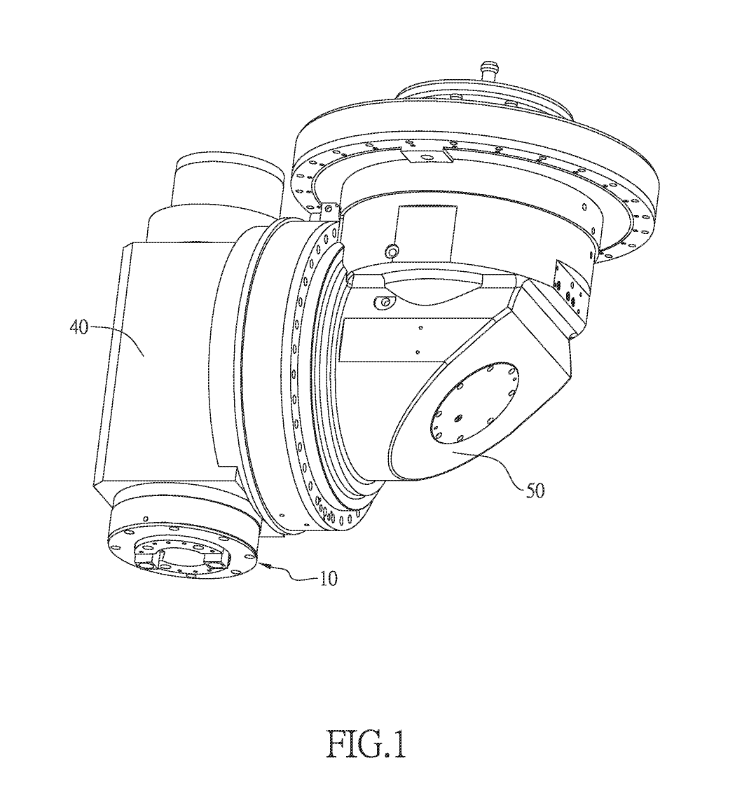

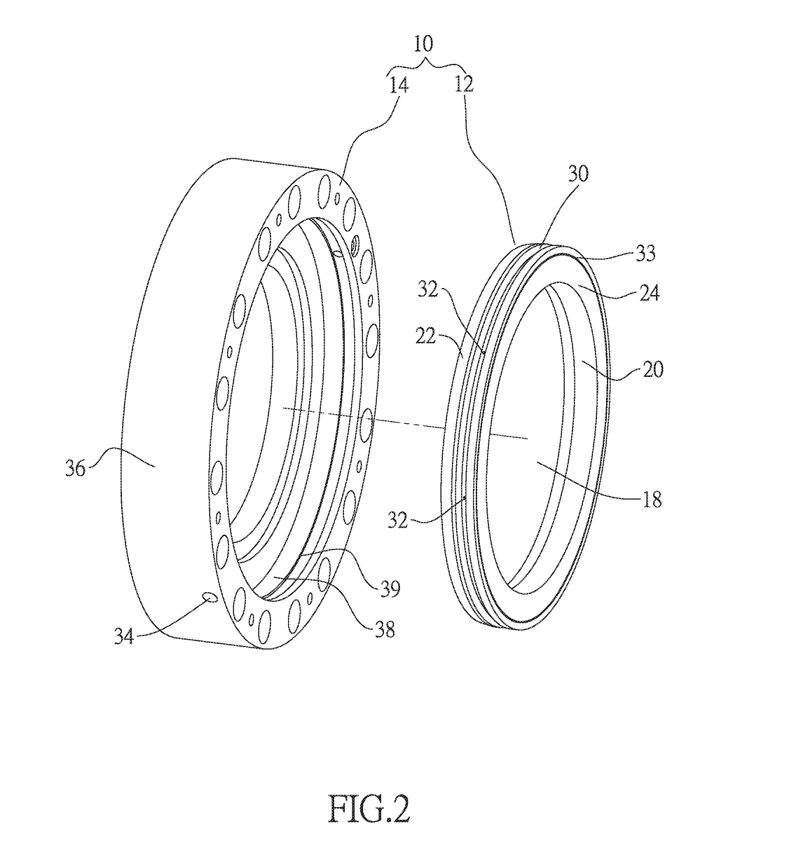

Referring to FIG. 1 and FIG. 2, an aerosol-based bearing isolator 10 provided by the preferred embodiment of the present invention is mounted on an attachment head spindle 40 that is capable for multi-angle processing and adapted for processing tools. The attachment head spindle 40 is mounted on an attachment head 50 that is capable for multi-axis processing and essentially comprises a sealing element 12 and a compressed air guiding element 14.

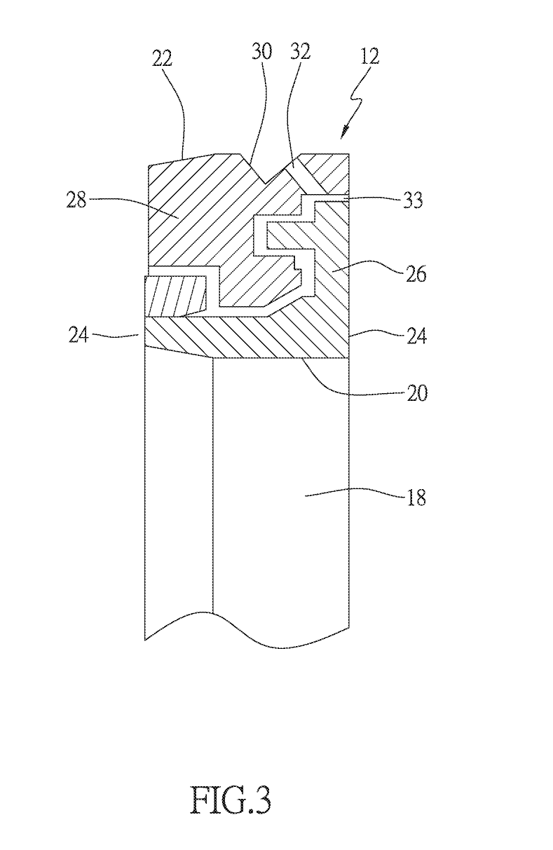

An axial hole 18 is centrally disposed at the sealing element 12. The sealing element 12 has an inner circumferential surface 20 which faces the axial hole 18. The sealing element 12 has an outer circumferential surface 22 which faces inner circumferential surface 38 of compressed air guiding element 14. The sealing element 12 further has two lateral surfaces 24, each of which adjoins the inner circumferential surface 20 and the outer circumferential surface 22. The sealing element 12 essentially comprises an inner member 26 and an outer member 28 as shown in FIG. 3 and disclosed in the prior art, and thus they are not described in detail herein for the sake of brevity.

Referring to FIG. 3, a compressed air path 30 is disposed on the outer circumferential surface 22 of the sealing element 12. The compressed air path 30 is a circumferential groove, and has a substantially V-shaped cross section. The sealing element 12 has a plurality of compressed air export channels 32. Each compressed air export channel 32 has one end exposed from the compressed air path 30 and thus is connected with the compressed air path 30 and the outside. In this embodiment, the compressed air path 30 and the compressed air export channels 32 are disposed at the outer member 28. Each compressed air export channel 32 has the other end in connected with a gap 33 disposed between the inner member 26 and the outer member 28. The gap 33 disposed between the inner member 26 and the outer member 28 is exposed from the lateral surface 24 of the sealing element 12 to form an annular opening thereon; hence, the compressed air export channels 32 are in connected with the compressed air path 30 and the outside. The compressed air export channels 32 disposed on the sealing element 12 are spaced apart equidistantly.

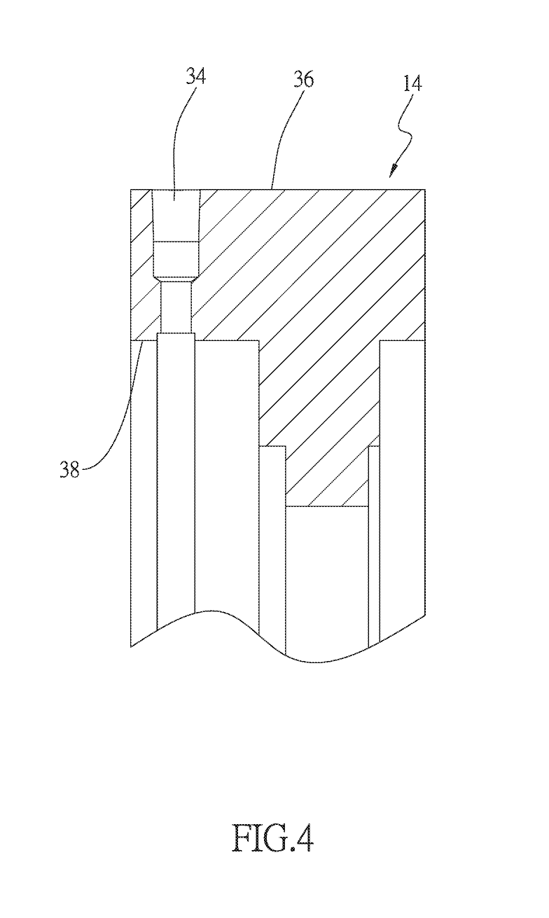

Referring to FIG. 4, the compressed air guiding element 14 is substantially annular and has a compressed air import hole import hole 34. The compressed air import hole 34 has one end exposed from an outer lateral surface 36 of the compressed air guiding element 14 to form an opening thereon and has the other end exposed from an inner lateral surface 38 of the compressed air guiding element 14 to form another opening thereon. In this embodiment, a groove 39 is disposed on the inner lateral surface 38 of the compressed air guiding element 14 and is in connected with the compressed air import hole 34.

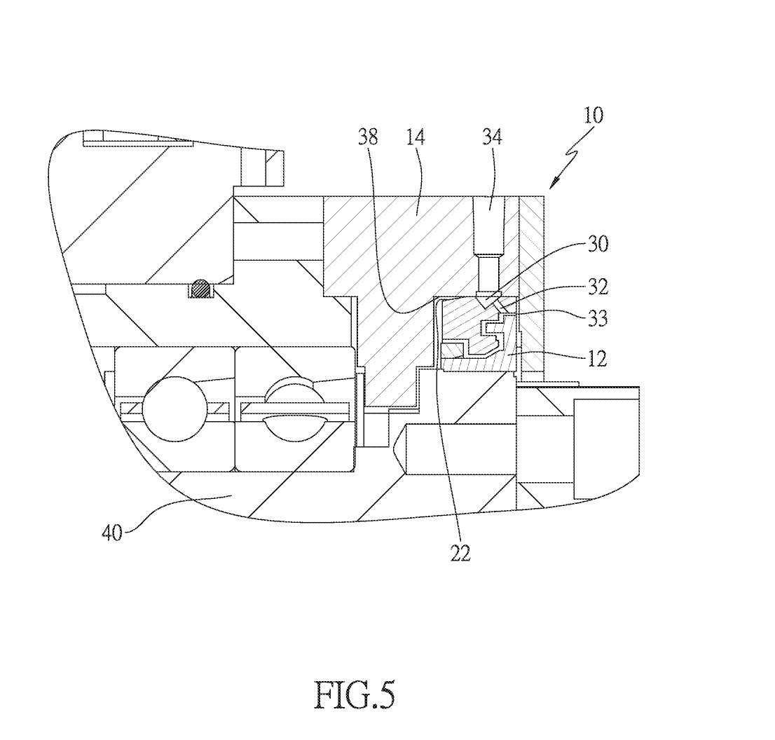

Referring to FIG. 5, the sealing element 12 is snugly mounted at the front end of the attachment head spindle 40 capable of multi-angle processing. The compressed air guiding element 14 is also snugly mounted on the attachment head spindle 40 capable of multi-angle processing. The inner lateral surface 38 of the compressed air guiding element 14 abuts against the outer circumferential surface 22 of the sealing element 12 in an airtight manner. The groove 39 of the compressed air guiding element 14 is in connected with the compressed air path 30 of the sealing element 12, and thus the compressed air import hole 34 is in connected with the compressed air path 30. Referring to FIG. 4, the compressed air import hole 34 of the compressed air guiding element 14 is connected to an air compressor (not shown). The air compressor provides compressed air which passes through the compressed air import hole 34, the groove 39 and the compressed air path 30 sequentially before being discharged from the compressed air export channels 32 to the outside.

Hence, the fact that the attachment head spindle capable of multi-angle processing can rotate and thus change its processing angle by more than 90 degrees, coupled with the air compressor's providing compressed air to a sealing element continuously, prevents a cutting fluid from reaching the sealing element to disadvantageously compromise the operation of the attachment head spindle capable of multi-angle processing.

1. An aerosol-based bearing isolator for an attachment head of a machine tool, comprising:
a compressed air guiding element having an annular shape and provided with a compressed air import hole, wherein the compressed air import hole has one end formed on an outer lateral surface of the compressed air guiding element, and has another end formed on an inner lateral surface of the compressed air guiding element; and
a sealing element being annular-shaped and having a central axial hole, wherein the sealing element is disposed in a hollow annular center of the compressed air guiding element, so that the inner lateral surface of the compressed air guiding element is abutted against an outer circumferential surface of the sealing element in an airtight manner, the sealing element has a compressed air path and a plurality of compressed air export channels, wherein the compressed air path is disposed on the outer circumferential surface of the sealing element, the compressed air export channels are disposed in the compressed air path and each have an end connected to the compressed air path; and thus the compressed air path is in communication with an outside.

2. The aerosol-based bearing isolator according to claim 1, wherein the compressed air path is a circumferential slot groove, and has a substantially V-shaped cross section.

3. The aerosol-based bearing isolator according to claim 1, wherein the compressed air export channels on the sealing element are spaced apart equidistantly.

4. The aerosol-based bearing isolator according to claim 1, wherein the compressed air import hole of the compressed air guiding element is connected to an air compressor.

5. The aerosol-based bearing isolator according to claim 1, wherein the sealing element has an inner member and an outer member, the compressed air path and the compressed air export channels are disposed on the outer member, a gap is disposed between the inner member and the outer member, and the gap forms an annular opening on a lateral surface of the sealing element, wherein the compressed air export channels are in communication with the gap.

6. The aerosol-based bearing isolator according to claim 1, wherein a groove is disposed on the inner lateral surface of the compressed air guiding element and is in communication with the compressed air import hole and the compressed air path of the sealing element.
